(19) United States
(12) Patent Application Publication
(10) Pub. No.: US 2022/0304275 A1
(43) Pub. Date: Sep. 29, 2022

(54) Bale Feeder Assembly

(71) Applicant: Don Jellis, Watertown, SD (US)

(72) Inventor: Don Jellis, Watertown, SD (US)

(21) Appl. No.: 17/210,575

(22) Filed: Mar. 24, 2021

(51) Int. Cl. A01K 1/10; A01K 5/01

(52) U.S. Cl. CPC A01K 1/10; A01K 5/01

(57) ABSTRACT

A bale feeder assembly includes a base comprising a horizontally orientated tire having a top wall, a bottom wall, and a perimeter wall extending between and being attached to the top and bottom walls. The top and bottom walls each have a centrally positioned opening extending therethrough. The perimeter wall has a height that is greater than 9.0 inches and the base is comprised of an elastomeric material. A feed container is positioned on and extends upwardly from the base. A hay bale is positioned in the feed container to provide feed to livestock.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to bale feeder device and more particularly pertains to a new bale feeder device for positioning a bale receptacle off of the ground while allowing fluid, such as rainwater, to freely flow away from a bale of hay.

### (2) Description of Related Art Including Information Disclosed Under 37 CFR 1.97 and 1.98

The prior art relates to bale feeder devices that are positioned on a ground surface and do not allow for free flow of fluid away from the bale.

### BRIEF SUMMARY OF THE INVENTION

An embodiment of the disclosure meets the needs presented above by generally comprising a base comprising a horizontally orientated tire having a top wall, a bottom wall, and a perimeter wall extending between and being attached to the top and bottom walls. The top and bottom walls each have a centrally positioned opening extending therethrough. The perimeter wall has a height that is greater than 9.0 inches and the base is comprised of an elastomeric material. A feed container is positioned on and extends upwardly from the base. A hay bale is positioned in the feed container to provide feed to livestock.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front and top isometric view of a bale feeder assembly according to an embodiment of the disclosure.

FIG. 2 is a side view of an embodiment of the disclosure.

FIG. 3 is a bottom view of an embodiment of the disclosure.

FIG. 4 is a cross-sectional view of an embodiment of the disclosure taken along line 4-4 of FIG. 2.

FIG. 5 is an in-use rear isometric view of an embodiment of the disclosure.

FIG. 6 is a front and top isometric view of an embodiment of the disclosure.

### DETAILED DESCRIPTION OF THE INVENTION

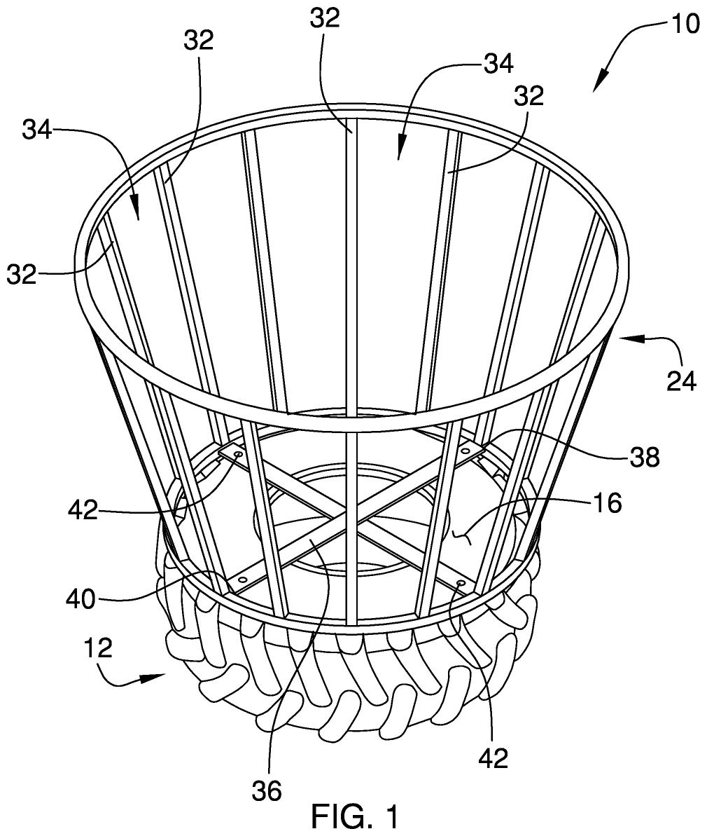

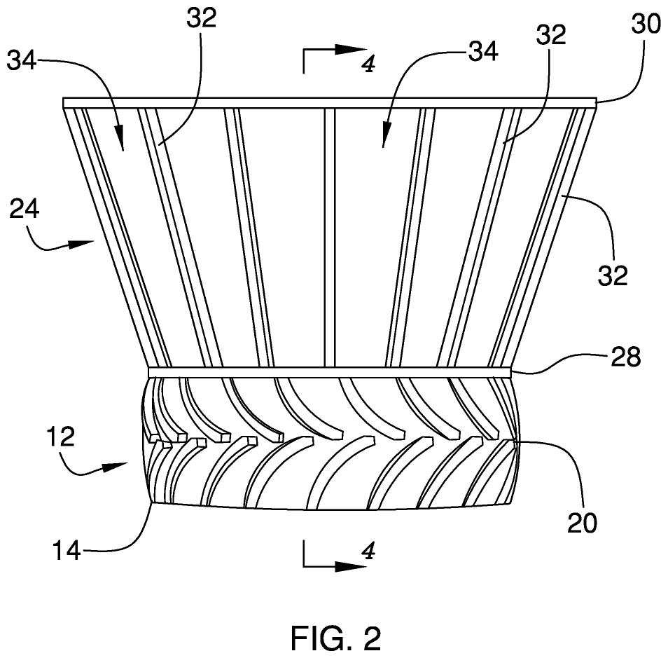

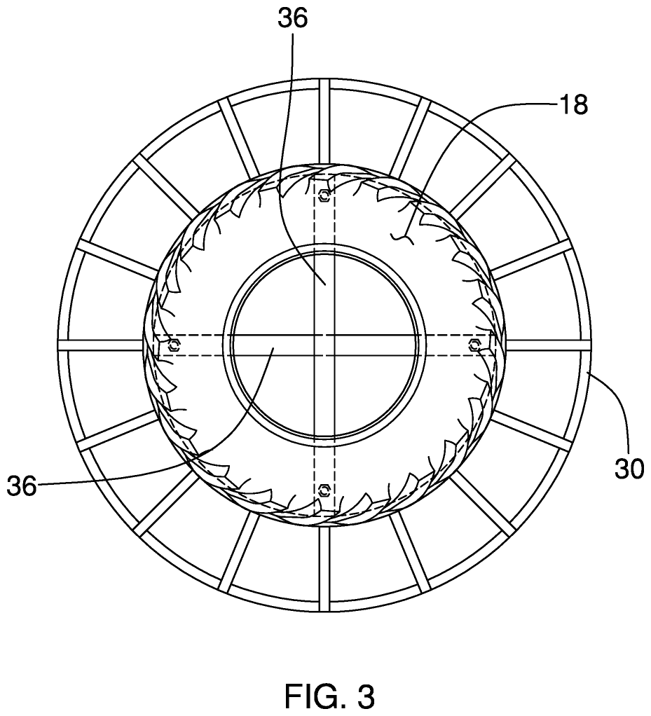

With reference now to the drawings, and in particular to FIGS. 1 through 6 thereof, a new bale feeder device embodying the principles and concepts of an embodiment of the disclosure and generally designated by the reference numeral 10 will be described.

As best illustrated in FIGS. 1 through 6, the bale feeder assembly 10 generally includes a base 12 comprising a horizontally orientated tire 14 having a top wall 16, a bottom wall 18, and a perimeter wall 20 extending between and attached to the top 16 and bottom 18 walls. The top 16 and bottom 18 walls each have a centrally positioned opening 22 extending therethrough. The perimeter wall 20 has a height that is greater than 9.0 inches and the base 12 is comprised of an elastomeric material. The base 12 is a conventional tire that may comprise, for instance, a used tractor tire wherein the perimeter wall 20 includes treading. The tire 14 will typically have a diameter of at least 4.0 feet.

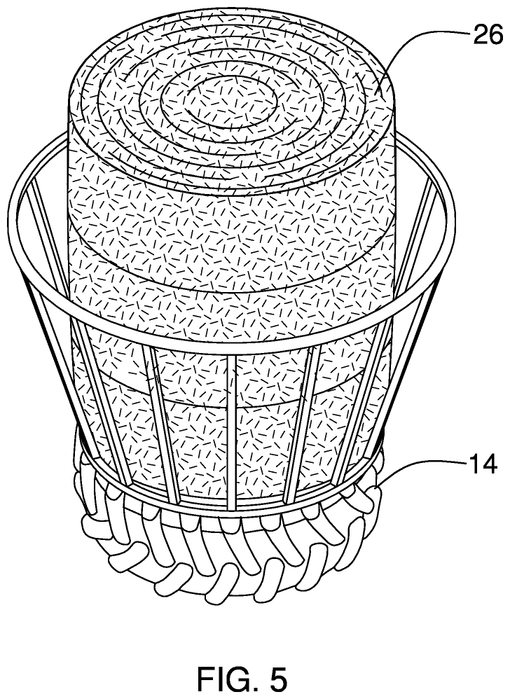

A feed container 24 is positioned on and extends upwardly from the base 12. The feed container 24 is configured for receiving a hay bale 26, such as a round hay bale 26 which is placed on its side as is shown in FIG. 5. The feed container 24 includes a bottom closed loop 28 and a top closed loop 30. Each of the top 30 and bottom 28 closed loops may have a circular shape. A plurality of vertical supports 32 is attached to and extends between the top 30 and bottom 28 closed loops. As can be seen in the Figures, the vertical supports 32, bottom closed loop 28 and top closed loop 30 may each be comprised of a same material such as a metallic material including steel alloys, for example. The vertical supports 32 may be rivetted or welded to the top 30 and bottom 28 closed loops. The vertical supports 32 are spaced from each other such that feeding gaps 34 are defined between the vertical supports 32. Typically, at least 50% of the feeding gaps 34 will have a width equal to at least 6.0 inches. As is shown in the Figures, the top closed loop 30 may have a greater diameter than the bottom closed loop 28 such that a diameter of the feed container 24 increases as it moves upwardly away from the base 12.

A plurality of bracing members 36 is provided and each has a first end 38 and a second end 40. Each of the first 38 and second 40 ends is attached to the bottom closed loop 28 such that the bracing members 36 traverse an area bound by the bottom closed loop 28. The bracing members 36 may be comprised of same material as a remainder of the feed container 24 and either mechanically fastened or welded to the bottom closed loop 28. The bracing members 36 may intersect an axis of the area bound by the bottom closed loop 28.

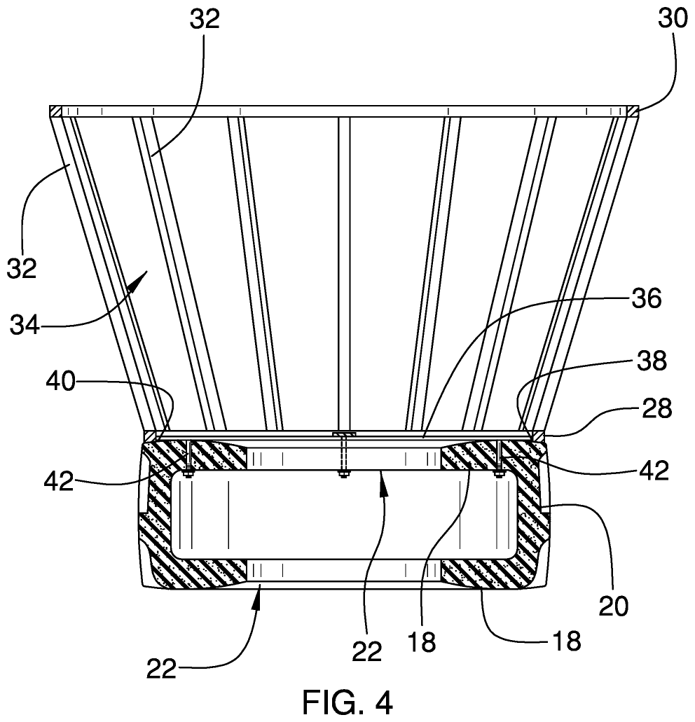

A plurality of fasteners 42 is used to secure the feed container 24 to the base 12. The fasteners 42 extend through the feed container 24 and into the base 12. In some embodiments, the fasteners 42 may extend through the bottom closed loop 28 and into the top wall 20. In an embodiment shown in FIG. 4, the fasteners 42 extend through the bracing members 36 such that each of the bracing members 36 has at least one of the fasteners 42 extending therethrough and into the top wall 16.

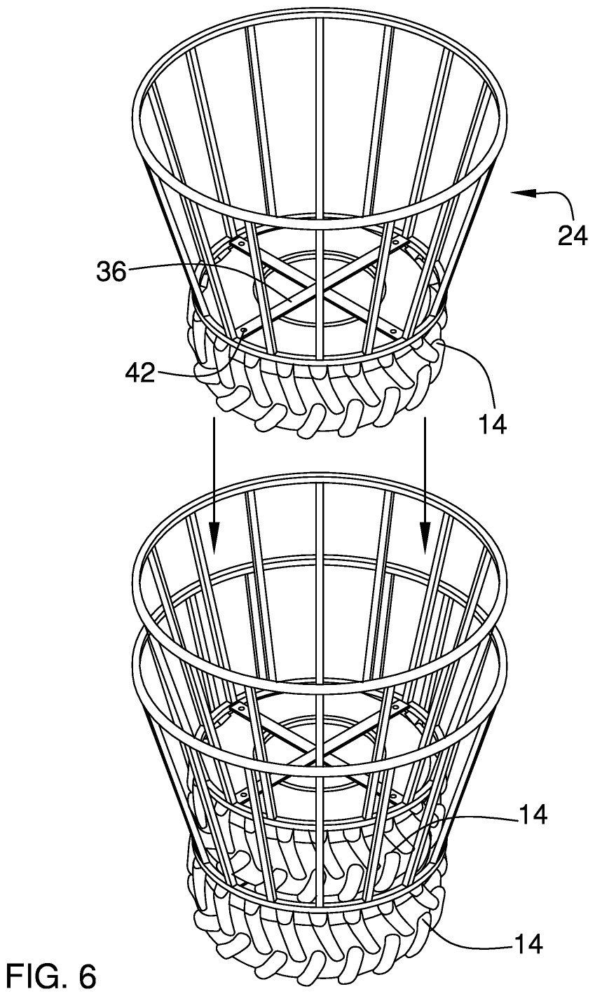

In use, the assembly 10 is used for receiving a bale such that can be used to feed livestock. The base raises the feed container off of the ground such that bale is not touching the ground and is readily accessible to livestock. The structure and shape of the feed container allows multiple ones of the assemblies 10 to be nested as is shown in FIG. 6. The tire further enhances the ability to grip and move the assembly 10 as needed.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A bale holding assembly comprising:
a base comprising a horizontally orientated tire having a top wall, a bottom wall, and a perimeter wall extending between and being attached to the top and bottom walls, the top and bottom walls each having a centrally positioned opening extending therethrough, the perimeter wall having a height being greater than 9.0 inches, the base being comprised of an elastomeric material; and
a feed container being positioned on and extending upwardly from the base, the feed container being configured for receiving a hay bale.

2. The bale holding assembly according to claim 1, wherein the feed container includes:
a bottom closed loop;
a top closed loop; and
a plurality of vertical supports being attached to and extending between the top and bottom closed loops, the vertical supports being spaced from each other such that feeding gaps are defined between the vertical supports.

3. The bale holding assembly according to claim 2, wherein at least 50% of the feeding gaps having a width equal to at least 6.0 inches.

4. The bale holding assembly according to claim 2, wherein each of the top and bottom closed loops have a circular shape.

5. The bale holding assembly according to claim 4, wherein the top closed loop has a greater diameter than the bottom closed loop.

6. The bale holding assembly according to claim 2, further including a plurality of bracing members each having a first end and a second end, each of the first and second ends being attached to the bottom closed loop such that the bracing members traverse an area bound by the bottom closed loop.

7. The bale holding assembly according to claim 6, further including a plurality of fasteners extending through the feed container and into the base.

8. The bale holding assembly according to claim 7, wherein each of the bracing members has at least one of the fasteners extending therethrough, each of the fasteners extending into the top wall.

9. The bale holding assembly according to claim 6, further including a plurality of fasteners extending through the feed container and into the base.

10. A bale holding assembly comprising:
a base comprising a horizontally orientated tire having a top wall, a bottom wall, and a perimeter wall extending between and being attached to the top and bottom walls, the top and bottom walls each having a centrally positioned opening extending therethrough, the perimeter wall having a height being greater than 9.0 inches, the base being comprised of an elastomeric material;
a feed container being positioned on and extending upwardly from the base, the feed being container configured for receiving a hay bale, the feed container including:
a bottom closed loop;
a top closed loop, each of the top and bottom closed loops having a circular shape;
a plurality of vertical supports being attached to and extending between the top and bottom closed loops, the vertical supports being spaced from each other such that feeding gaps are defined between the vertical supports, at least 50% of the feeding gaps having a width equal to at least 6.0 inches;
the top closed loop having a greater diameter than the bottom closed loop;
a plurality of bracing members each having a first end and a second end, each of the first and second ends being attached to the bottom closed loop such that the bracing members traverse an area bound by the bottom closed loop; and
a plurality of fasteners extending through the feed container and into the base, each of the bracing members having at least one of the fasteners extending therethrough, each of the fasteners extending into the top wall.
